(19) United States
(12) Patent Application Publication
(10) Pub. No.: US 2018/0100266 A1
(43) Pub. Date: Apr. 12, 2018

(54) METHOD OF TREATING SILICA FABRIC

(71) Applicant: GelTech Solutions, Inc., Jupiter, FL (US)

(72) Inventor: Peter Cordani, Jupiter, FL (US)

(21) Appl. No.: 15/730,151

(22) Filed: Oct. 11, 2017

Related U.S. Application Data
(60) Provisional application No. 62/406,638, filed on Oct. 11, 2016.

(51) Int. Cl. D06M 15/59; D06M 15/715; D06M 13/224; C09D 133/26; C09K 21/14; A62C 3/02; A62C 5/033

(52) U.S. Cl. CPC D06M 15/59; D06M 15/715; D06M 13/224; D06M 2101/16; C09K 21/14; A62C 3/0257; A62C 5/033; C09D 133/26

(57) ABSTRACT

A method of treating silica fabric blankets to enhance the material from high temperatures and fire. The method comprising the steps of: coating a silica fabric blanket with dry superabsorbent polymer, storing the coated blanket in a water proof container, hydrating the coated blanket with water and covering a person or object with the hydrated coated blanket to provide enhanced protection to the person or object from high temperatures and fire.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 62/406,638, entitled “METHOD OF TREATING SILICA FABRIC”, filed Oct. 11, 2016. The contents of which the above referenced application is incorporated herein by reference.

### FIELD OF THE INVENTION

This invention relates to the field of fabric coatings, and more particularly to a method of treating silica fabrics to enhance protection of humans and objects from high temperatures and fire during emergency situations.

### BACKGROUND OF THE INVENTION

Silica and fiberglass fabrics are used in most any application that can benefit from a heat barrier. With temperature resistance of 2,000° F. or more, the fabric can be adapted to protect most any object that is subjected to high temperatures. These fabrics typically do not burn but they can melt. For example, one industrial use of silica blankets is for welder processes wherein the silica blanket is used to catch hot slag, arcs, splatter, and torch cut debris during a welding procedure. The silica blanket allows the welder to protect most any item that would otherwise be scarred by hot welding debris. Another commercial use of silica blankets is to protect surfaces from a fireworks display. Fireworks have a high temperature discharge and the use of silica blankets can protect the launching pad from damage.

An emergency use of silica blankets is by first responders for the protection of humans caught in a fire. The silica blanket is lightweight and under good conditions can be wrapped around most any person or object to provide temporary protection from the heat. However, the ability to remove an occupant from a burning home requires a number of factors to occur in favor of a successful extraction. The individual's location in respect to the fire both in temperature and distance to an exit. The extent and intensity of the open flames. The debris field created by the fire that an individual most overcome to escape. All of the above is compounded by an element of time, the longer an individual is exposed to fire and heat, the more susceptible the individual is to harm.

The intensity of a home fire can quickly exceed 1000° F., so the use of a silica fabric would be beneficial to shield the occupant from flames but the embers from the silica fabric can still cause burns. Human skin will develop first degree burns at about 120° F. Therefore, what is needed is a blanket for the occupant that extends the amount of time the occupant can endure within the fire field, and heighten the temperature that an individual is able to withstand without injury.

U.S. Pat. No. 5,190,110 discloses the fighting of fires and protection of objects from fire by applying an admixture which comprises dispersing in the water particles of a cross-linked, water-insoluble, but highly water-swellable, acrylic acid derivative polymer in an amount insufficient to bring the viscosity above 100 mPa's. The particles are present in an amount such that, after swelling, the swollen particles hold 60 to 70% by weight of the total water; the polymer being a copolymer of an acrylic acid, the water containing silicic acid and/or a silicate as well as sodium, potassium or ammonium ions.

U.S. Pat. No. 5,849,210 discloses a method of preventing or retarding a combustible object from burning including the steps of mixing water with a super absorbent polymer (“SAP”) to form one at least partially hydrated SAP, and applying the at least partially hydrated SAP to the combustible object, before or after combustion.

U.S. Pat. No. 5,087,513 discloses polybenzimidazole polymer/superabsorbent polymer articles are prepared by either mixing the super absorbent polymer particulates with the polybenzimidazole polymer solution during the formation of the polybenzimidazole article, or forming a composite of a polybenzimidazole film or fiber material layer with a super absorbent polymer particulate containing layer.

U.S. Pat. No. 4,978,460 discloses an additive for water for firefighting containing a strongly swelling water-insoluble high molecular weight polymer as a gelatinizing agent, which comprises a water-soluble release agent which causes the particles of said gelatinizing agent not to swell, the particles of the gelatinizing agent being encased or dispersed in the release agent. Suitable release agents include polyethylene glycol, sugars, mannitol, etc. The gelatinizing agent may be a moderately cross-linked water-insoluble acrylic or methacrylic acid copolymer.

What is lacking in the art is a method of improving a blanket to provide a greater possibility of dissipating heat and protecting for a covered human or object, to protect the individual from temperatures and fire.

### SUMMARY OF THE INVENTION

Disclosed is a method of treating a silica fabric blanket to enhance the fabric's protective qualities regarding from high temperatures and fire. The method comprising the steps of: coating silica fabric with dry superabsorbent polymer and storing the coated silica fabric in a waterproof container until needed. When a need arises, the coated silica fabric is hydrated with water essentially activating the superabsorbent polymer. A person or object can then be covered with the hydrated coated silica fabric blanket to provide enhanced protection from high temperatures and fire.

An objective of the invention is to teach a method of enhancing the protection of a silica fabric by use of a hydrated superabsorbent material.

Still another objective of the invention is to disclose a coated silica fabric that can be stored indefinitely without adding weight to the silica fabric to provide immediate protection by applying water.

Still another objective of the invention is to disclose a coated silica fabric that provides superior protection of objects during welding operations.

Yet still another objective of the invention is to disclose a coated silica fabric that provides a lightweight blanket for firefighters and can be activated on site by most any water source.

Other objectives and advantages of this invention will become apparent from the following description and certain embodiments of this invention.

### BRIEF DESCRIPTION OF THE DRAWINGS

No drawings provided.

### DETAILED DESCRIPTION OF THE PREFERRED EMBODIMENT

Silica based blankets have various contents of fiberglass and silicon dioxide. The instant invention improves all types of silica blankets. For purposes of this disclosure, conventional fiberglass blankets have a silicon dioxide content of about 52% to 56%, a melting point of about 2000° F., and are not considered fireproof. Silica blankets have a silicon dioxide content of greater than 95%, a melting point of about 3000° F., and are considered fireproof. The silica blankets have a generally satin weave, are soft and pliable.

The instant invention teaches the use of the silica fabric to be treated with a super absorbent polymer, either a cross-linked modified polyacrylamides/potassium acrylate or cross-linked polyacrylamides/sodium acrylate. Other suitable polymers include, albeit are not limited to, carboxy-methylcellulose, alginic acid, cross-linked starches, and cross-linked polyaminoacids. The preferred super absorbent polymer for treating of the fabric is sold under the trademark FIREICE® from the GelTech Corporation.

The silica fabric blanket is treated with the superabsorbent polymer by applying dry polymer directly to a dry silica fabric. Light brushing or rubbing of the polymer onto the fabric causes adhesion of the polymer to the fabric, both in a charged attraction and with a physical attachment. The polymer is rubbed with sufficient pressure to cause the integration of the polymer to mechanically be trapped with the fabric material. Preferably both sides of the blanket are treated to enhance the amount of sites capable of being hydrated. Sufficient pressure forces the polymer to be trapped by the fabric, yet does not cause excessive sheering of the polymer to loss effectiveness. The trapped and attached polymer can hold over 60% by weight of water.

The coated silica blanket is stored dry, and maintained in a dry state by sealing within a container such as a plastic bag. The plastic bag maintains the blanket in a dry state allowing for ease of storage and movement. The polymer is inert and can be stored indefinitely as long as the container seal remains secure. The polymer adding negligible weight to the silica fabric, the weight of the silica fabric is preferably 18, 32 or 36 oz/yd². The container can be formed so that the coated blanket is stored in a tight container as possible. For instance, a vacuum can be drawn on the container so that no air is trapped in the container allows for compact storage. Further, the coated silica blanket can be pressed under pressure wherein the blanket can be further reduced in size. The polymer coating acting as a lubricant to prevent damage to the fibers during a pressure press.

When a need arises, the blanket can be moistened with water from most any source, causing instant saturation of the polymer; the hydrated polymer creating an increase in the protection afforded the blanket. Even if the blanked was pressed to a smaller size under pressure, water activates the polymer allowing them to retain the water while removing the fabric from the pressed condition without damage to the fabric.

The hydrated super absorbent polymer has substantially superior fire suppression and extinguishing properties than the fire suppression and extinguishing properties of plain water. One of the unique properties of the admixture is its ability to cling to the blanket to which it has been applied, and both cool down the blanket when subjected to fire, and create a block to inhibit fire from melting through the blanket.

The method of treating silica fabrics to enhance said fabric from high temperatures and fire comprises the steps of: coating each yd² of silica fabric with about 1 ounce of dry superabsorbent polymer; storing the coated silica fabric in a waterproof container; removing said coated silica fabric from said waterproof container; hydrating said coated silica fabric with water; and covering a person or object with the hydrated coated silica fabric, wherein said hydrated coated silica fabric provides enhanced protection from high temperatures and fire. The dry superabsorbent polymer can rubbed into the fabric, the polymer having a natural tendency to adhere to the fabric and the size of the polymer causes it to become instantly embedded within the strands of the fabric.

Water may be placed into the container to cause hydration. For example, forest firefighters carry various types of fire blankets with them in case they become trapped by a fire. Proper use of a blanket is to cover the firefighter's body and allow the fire to pass over the firefighter. Unfortunately, the heat from a fire can be so intense that the skin of the firefighter can burn beneath the blanket. The use of a hydrated silica blanket provides enhanced temperature protection by allowing for heat dissipation. A forest firefighter may use water from any available source to hydrate the blanket, including river water, swimming pool water, bottled water and the like. Hydration of the coated silica blanket increases the temperature resistance of the silica fabric, and more importantly, provides a moisture barrier to prevent isolated melting of the fabric caused by hot embers which allows heat dissipation to protect the skin.

Another example is the use of blankets by welders. For this example, the Applicant refers to welding on ships, wherein hot slag, arcs and splatter can not only result in damage to the floor coatings, in many such instances, wiring harnesses and pipes may be detrimentally affected. Dropping of hot slag on conventional blankets can result in melting of the blanket within 15 seconds. Employment of the hydrated blanket eliminates melting; the hydrated polymer cooling off the slag well before fabric melting points are reached.

Another example is the use of blankets by professional firefighters who carry various blankets with them in case they need to extract an individual or pet trapped by a fire. Proper use of a blanket is to cover the body of the individual during the extraction process. Unfortunately, the heat from a fire can be so intense that the skin of the individual can burn beneath the blanket. In this example, the coated silica blanket is moistened with water and the hydrated blanket wrapped around the individual, providing enhanced temperature protection by allowing for heat dissipation. Hydration of the coated silica blanket increases the temperature resistance of the silica fabric, and again provides a moisture barrier to prevent isolated melting of the fabric caused by hot embers, and further allows heat dissipation to protect the skin.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claim is:

1. A method of treating silica fabric material and use of the treated silica fabric to enhance the fabric materials for use as blankets from high temperatures and fire, said method comprising the steps of:
coating each yd² of silica fabric with about 1 ounce of dry superabsorbent polymer;
storing the coated silica fabric in a waterproof container;
removing said coated silica fabric from said waterproof container;
hydrating said coated silica fabric with water;
covering a person or object with the hydrated coated silica fabric;
wherein said hydrated coated silica fabric provides enhanced protection from high temperatures and fire.

2. The method of treating silica fabrics according to claim 1 wherein each said yd² of silica fabric weighs about 18 ounces.

3. The method of treating silica fabrics according to claim 1 wherein each said yd² of silica fabric weighs about 36 ounces.

4. The method of treating silica fabrics according to claim 1 wherein each super absorbent polymer is a cross-linked modified polyacrylamides/potassium acrylate.

5. The method of treating silica fabrics according to claim 1 wherein each super absorbent polymer is a cross-linked modified polyacrylamides/sodium acrylate.

6. The method of treating silica fabrics according to claim 1 including the step of vacuuming air from said water proof container.

7. The method of treating silica fabrics according to claim 1 including the step of pressing said blanket with pressure to provide a compact storage of said blanket.

8. The method of treating silica fabrics according to claim 1 wherein said superabsorbent polymer is marketed under the trademark FireIce®.
